(19) United States
(12) Patent Application Publication
(10) Pub. No.: US 2020/0296945 A1
(43) Pub. Date: Sep. 24, 2020

(54) Device for Alternative Fishing Hook Arrangement

(71) Applicant: Matthew Bryan Jeffries, Sammamish, WA (US)

(72) Inventor: Matthew Bryan Jeffries, Sammamish, WA (US)

(21) Appl. No.: 16/357,614

(22) Filed: Mar. 19, 2019

(51) Int. Cl. A01K 83/06; A01K 95/02; A01K 91/02

(52) U.S. Cl. CPC A01K 83/06; A01K 85/00; A01K 91/02; A01K 95/02

(57) ABSTRACT

A device for rigging a fishing lure having a hollow cylindrical main body with a first tapered end and a second non-tapered end, such that the tapered end is sized to fit snugly on an artificial fishing worm lure. The device has a number of holes distributed around the central portion of the main body to enable the passage of a fishing hook through the lure and device combination. The device may be constructed of plastic, metal, rubber, or a combination of materials. The device may be weighted or have additional embellishments to enhance an angler's fishing success.

### BACKGROUND

### Field of the Invention

The present invention relates generally to devices for fishing. More specifically, the present invention relates to devices to enable alternative hook arrangements with a fishing lure.

### Description of the Related Art

In the field of fishing, a number of predominant hook arrangements exist, such as Texas rigging, Carolina rigging, Chod rigging, Hair rigging, and Wacky rigging. For Texas and Wacky rigging, the fishing hook is threaded through the body of a fishing worm, either live or artificial. For artificial worms, this weakens the material of the body of the worm.

In the current state of the art, bands, typically made of rubber, are used to allow the fishing hook to be attached through them instead of the lure; however, special tools were needed to assist the anglers to achieve the desired threading. These tools can be difficult to use, or they can be misplaced or lost, which then makes changing rigging in the middle of a fishing expedition difficult.

With these bands, an angler that wants to transition from one hook arrangement to another, such as Wacky rigging to Texas rigging, would often have to cut their fishing line and retie all the components for the desired rigging arrangement. Similarly, if the angler wanted to transition from a weightless to a weighted arrangement, a similar process would be needed, which can be cumbersome and time consuming.

### SUMMARY

In accordance with the embodiments herein, a fishing device is disclosed. The device generally has a hollow cylindrical body with one tapered end and a number of holes on the main body, allowing for a fishing hook to be passed through a lure. The tapered end is smaller than the diameter of a typical fishing worm to ensure the stability of the main body while attached to the fishing lure.

### BRIEF DESCRIPTION OF THE DRAWINGS

FIG. 1 shows a view of the device.

FIG. 2 shows an alternative view of the device.

FIG. 3 shows the device in arrangement for Texas rigging with an artificial fishing worm.

FIG. 4 shows the device in arrangement for Wacky rigging with an artificial fishing worm.

### DETAILED DESCRIPTION OF EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention.

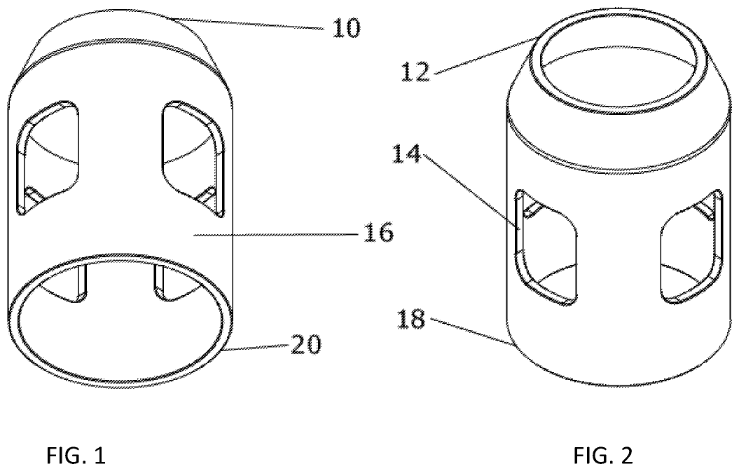

In an illustrative embodiment of the invention, as shown in FIGS. 1 and 2, the device has a hollow main body, 16, in a cylindrical shape sized such that an artificial fishing worm will fit through the opening of the hollow body. The main body has a tapered end, 10, opposed to a non-tapered end, 20. The opening of the tapered end, 12, is sized such that the device will fit securely on the artificial fishing worm in a manner that will hold the device in place on the worm. The opening of the non-tapered end of the main body, 18, is the same size as the cylinder of the main body. A number of holes, 14, are placed along the main body, typically in a fashion such that the holes are opposed to each other across the main body but not necessarily. The main body may have a single hole, or it may have a number of holes. The holes are typically in a rectangular shape, but could be any number of other shapes, such as circular, square, hexagonal, or rhomboid.

The main body could be made of any number of materials, such as plastic, metals, or rubbers. The main body could also be made from combinations of materials. For metal construction of the main body, brass, zinc, tungsten, lead, and composites of those metals are the most common, but other metals are contemplated. Silicon rubber is most commonly used for rubber construction of the main body, but other rubbers are contemplated.

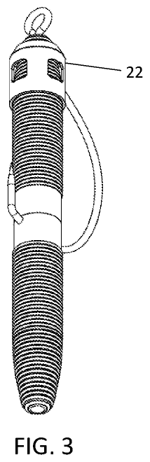

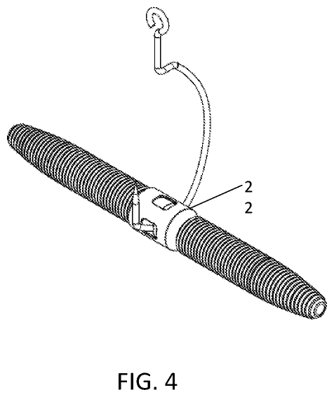

The device can be used in both Texas rigging, as shown in FIG. 3, or Wacky rigging, as shown in FIG. 4. When used in Texas rigging, the device 22 is connected to one end of a fishing lure, with a hook passed through one of the holes in the main body such that the loop of the hook for the fishing line comes out of the end of the fishing lure. The hook is then passed through a central portion of the lure. This arrangement allows for the lure to be parallel with the body of the hook.

When used in Wacky rigging, the device 22 is centrally located on the fishing lure. A hook is then passed through one, or multiple, of the holes along the main body such that the lure is perpendicular to the body of the hook.

In an additional embodiment, the device can be configured such that the main body is weighted, either through attached weight as part of the main body or through weights attached to the main body through an assembly mechanism. These weights can allow for different action while fishing or for fishing in different areas of the water, such as mid-water or bottom.

A further embodiment is such that the main body has a number of embellishments attached to it. These embellishments can be spinners, rattles, skirts, dressings, or other embellishments that could be used to increase the likelihood of a fish taking interest in a lure.

What is claimed is:

1. A fishing device, comprising:
a hollow cylindrical main body with a tapered end opposed to a non-tapered end; and
at least one aperture on the main body to allow for the passage of a fishing hook; and
wherein the tapered end is smaller than the diameter of a fishing lure to ensure the stability of the main body while attached to the fishing lure.

2. The device of claim 1, wherein the main body is made of a material selected from the group consisting of plastic, metal, rubber, and composites thereof.

3. The device of claim 2, wherein the metal is selected from the group consisting of brass, zinc, tungsten, lead, and composites thereof.

4. The device of claim 1, wherein two apertures are on the main body.

5. The device of claim 1, wherein four apertures are on the main body.

6. The device of claim 1, wherein the main body is open at both ends to allow for a fishing lure to be passed through the main body.

7. The device of claim 1, wherein the fishing lure is a worm.

8. The device of claim 7, wherein the worm is selected from the group consisting of live worm and artificial worm.

9. The device of claim 1, wherein the device is connected to the end of the fishing lure.

10. The device of claim 1, wherein the device is connected to a portion of the fishing lure disparate from the ends.

11. The device of claim 1, wherein the fishing device is connected to an end of the fishing lure, such that a fishing hook with a loop fixture can be passed through both the fishing lure and the fishing device, and wherein the loop fixture passes through the tapered end of the fishing device.

12. The device of claim 1, further comprising at least one weight connected to the main body.

13. The device of claim 1, further comprising at least one assembly on the main body to allow for at least one fishing weight to attached to the main body.

14. The device of claim 1, further comprising at least one embellishment on the main body.

15. The device of claim 14, wherein the at least one embellishment is selected from the group consisting of spinners, rattles, skirts, and dressings.
